(19) United States
(12) Patent Application Publication
(10) Pub. No.: US 2026/0260651 A1
(43) Pub. Date: Sep. 3, 2026

(54) System for supporting a user in the evaluation of image data

(71) Applicant: SICK AG, Waldkirch (DE)

(72) Inventors: Tim FISCHER, Freiburg (DE); Peter SCHMITT, Emmendingen (DE); Felix SCHWER, Freiburg (DE)

(21) Appl. No.: 19/536,705

(22) Filed: Feb. 11, 2026

(30) Foreign Application Priority Data
Mar. 3, 2025 (EP) 25161263.6

(51) Int. Cl. G10L 15/22; G06F 3/0482

(52) U.S. Cl. CPC G10L 15/22; G06F 3/0482

(57) ABSTRACT

The invention relates to a system, in particular a safety system, for supporting a user in the analysis of image data, said system comprising: at least one camera for detecting an environment and for generating associated image data, a data processing unit that comprises least one AI model with zero-shot capability for processing the image data, and a user interface for inputting a user query in natural language, wherein the AI model is configured to output, based on the image data and the user query, output information in response to the user query, in particular in real time, and wherein the data processing unit is configured to trigger a response action based on the output information.

The invention relates to a system and a method for supporting a user in the evaluation of image data.

Image processing systems, such as computer vision systems, are increasingly being used in many industrial applications and are used to provide intelligent systems and to support users of such applications. Such systems can in particular be helpful for monitoring rooms, areas, working equipment and the like.

Specialized systems already exist that are, for example, adapted to recognize certain properties in images, e.g. the presence of certain objects. However, these systems are often inflexible and are complex to use. For example, these systems are limited to recognizing or classifying objects without being able to satisfy further more complex tasks. Furthermore, the systems often require a user who has technical training to be able to integrate, adapt and use the systems.

It is thus an object of the invention to provide an improved system and method for supporting a user in an industrial environment.

This object is satisfied by the subjects of the independent claims.

The invention relates to a system, in particular a safety system or safety assistance system, preferably for controlling an industrial machine or an application in an industrial environment, for supporting a user in the evaluation of image data, said system comprising:
at least one imaging sensor for detecting an environment and for generating associated image data,
a data processing unit that comprises least one AI model with zero-shot capability for processing the image data,
and a user interface for inputting a user query in natural language,
wherein the AI model is configured to output, based on the image data and the user query, output information in response to the user query, in particular in real time, and
wherein the data processing unit is configured to trigger a response action based on the output information. The response action can preferably cause an action of an industrial machine or an application in an industrial environment, for example, the activation of an actuator of the industrial machine.

The invention is based on the realization that, based on a zero-shot-capable AI model, a plurality of different user queries can be processed without previously being limited to a specific area of work, for example. Via the user interface, the user of the system can input any desired user query that relates to the environment detected by the imaging sensor. The AI model receives the image data and the user query as input and outputs output information as output. The output information can, for example, be a text response to the user query, in particular in natural language. Based on the output information, the system can then trigger a suitable response reaction. The response action can comprise any desired action, in particular one that can be perceived in the real world.

In this context, a zero-shot capability or zero-shot performance is understood as the AI model using contextual knowledge, for example, to query or identify implicit properties in the image data. In other words, the AI model is in particular capable of performing a task for which said AI model has not seen any explicit examples during the training. For example, the AI model uses its understanding of the context and its own internal representations to draw conclusions about desired and/or requested properties. The system according to the invention offers the advantage that it is flexible and adaptable and can in particular be applied to new tasks or issues with little effort. In particular, the AI model can process different types of user queries that are explained in more detail in a later section.

As described above, the system comprises a user interface, in particular a graphical user interface (GUI), via which a user can input respective user queries, in particular questions about the environment detected by the imaging sensor, in natural language. The user interface is thus in particular designed as a “no-code” user interface, i.e. a user does not need any programming knowledge to interact with the system and to make user queries. Since the system is able to process the user queries in natural language, the operation is significantly simplified for the user. In particular, user queries can be processed that would only be possible in comparable systems of the prior art through a complex adaptation of the image processing system that usually requires personnel with appropriate technical training. This makes a broader selection of questions possible for the user and thus an improved and increased exchange of information.

Questions such as “Are the lines on the floor still clearly visible?” or “Does this region need to be cleaned?” or “Is this person wearing a hard hat?” can be processed and answered by the system without a specific adaptation of an algorithm to the respective question and/or to the features in the image data that are relevant in this respect being necessary. Rather, the AI model is configured to answer the questions on the basis of its underlying context information, i.e. by using a zero-shot-capable AI model. Due to the possibility of asking any question relating to the image data in natural language, the time normally required for implementing the function associated with a question is thus in particular minimized. It enables the user of the system to formulate new user queries regarding the information of the image data at time intervals that are as short as desired. In particular, a continuous exchange with the user in bidirectional communication takes place in real time and in natural language so that user queries can be adapted and/or specified according to the responses. Due to the immediate feedback to the user, queries can be improved and the quality of results can be increased. Furthermore, an adaptation of the AI model to new user requirements is possible at any time, for example, by validating the outputs of the AI model by the user and optimizing the AI model based on the validated outputs with regard to the user requirement. This can in particular take place without program knowledge of the user.

As already indicated, the user queries are usually location-based queries and preferably at least indirectly or directly comprise location-based information. A location-based query is, for example, a query for which the expected content of the image is known. With imaging sensors attached in a stationary manner, the location information is constant, for example. If the system, for example, comprises only one imaging sensor, the location to which the query refers is in particular determined by the position and/or orientation of the imaging sensor. However, the location can also be specified directly by the user via a coordinate entry or by the specification of location information in the user query or can be extracted using a sample image. If the system, for example, comprises a plurality of imaging sensors, which are in particular attached at different locations and/or detect different environments or regions of the environment, an imaging sensor whose image data are used for processing the user query can be selected based on the location-related information specified by the user. Information about the orientation and/or the global position of the imaging sensor can be detected via MEMS inertial sensors, e.g. acceleration sensors, angular rate sensors and/or magnetic field sensors.

The user interface can in particular comprise input means for inputting the user query, e.g. a keyboard, a touch screen and/or a microphone, and/or output means for outputting the output information, e.g. a display unit (display), a loudspeaker and/or a signal light.

The imaging sensor can in particular comprise a 2D camera, e.g. an RGB camera, a monochrome camera or an IR camera, a 3D camera, e.g. consisting of a plurality of stereo cameras or a TOF camera, and/or a LIDAR sensor or a laser scanner for detecting the environment. The system can further comprise a plurality of imaging sensors. For example, the AI model implemented on the data processing unit can be configured to generate the output information based on the image data of one of the plurality of imaging sensors or based on the image data of more of the plurality of imaging sensors. Depending on the area of use, the environment can be a warehouse, a storage room, a predefined monitoring zone within a room and the like. The region of the environment that is detected by the imaging sensor can in particular change over time, for example, by changing the position and/or orientation of the imaging sensor.

Before the respective image data, the user query or the user query data associated with the user query and/or the sensor data described in a later section are processed by the AI model, the respective data can be pre-processed in order to bring them into a form that can be processed by the AI model. The pre-processing can, for example, comprise at least one of the following steps: cleaning, normalization, scaling, feature extraction, coding, augmentation or format conversion. The data processing unit is in particular connected to the imaging sensor and the user interface via a respective data connection. The transmission between the imaging sensor and the data processing unit in particular takes place in serialized form (serial communication), for example, via Ethernet. The transmission can take place via any desired bus systems (field buses) and/or any desired network protocol; in particular technologies such as USB, Ethernet and/or GigEVision can be used.

The system is in particular suitable for use in an industrial environment, for example, in a smart factory. The system can, for example, be a system for determining a stock level, a system for determining the condition of a warehouse, a system for determining hazards, e.g. in a warehouse, and the like. The system can therefore be used to achieve a checking and/or monitoring of the detected environment or of a predefined monitoring zone in the environment and thus to achieve increased safety in the corresponding area of use. The system is preferably used as a safety system in logistics automation or factory automation. Accordingly, the user queries can in particular comprise safety-related or safety-relevant entries and/or questions. Examples of user queries are:
Are the employees wearing the prescribed helmets, safety vests or safety shoes?
Are the shelves properly and securely put away?
Are there any tripping hazards along the way?
Are there objects (e.g. canisters) in the region that should not be there?
Can open cable ends be recognized in the region?
Are the specific safety devices active? For example, is the door to the robot cell closed?

Further embodiments of the invention can be seen from the description, from the dependent claims and from the drawings.

According to a first embodiment, the AI model is trained based on training image data and associated training output information, in particular wherein the training image data are based on the detected environment. The AI model is therefore optimized by a training process to answer user queries about the environment detected by the imaging sensor. For this purpose, the model is in particular trained with training image data and the associated training output information. The training image data can represent visual information that is used, for example, to recognize relevant features and patterns in the environment. The associated training output information includes the expected responses and/or classifications for the respective training images so that the model is in particular prepared by supervised learning for the subsequent use.

In a preferred embodiment, the training image data are generated based on the environment that is detected by the imaging sensor when the system is in use. This means that the training images can either be recorded directly in the target environment or can be generated synthetically to simulate typical scenarios of this environment. The model can thereby be intentionally tailored to the specific conditions of the detected environment or the detected region, which improves the accuracy and reliability of the responses.

The generation of the training image data can, for example, comprise at least one of the following steps:
acquisition of real image data by imaging sensors or other sensors in the detected region,
simulation and synthetic data generation in which environmental conditions, light conditions or objects are variably simulated,
extension of the training data set by methods such as data augmentation in order to consider variations in perspective, illumination or object position.

By using environment-specific training data, the AI model can better respond to typical scenarios and potential anomalies in the monitored environment, whereby the quality of the responses to user queries is optimized. The training data can in this respect come from different sources:

### Images and Videos of Imaging Sensors

The training image data can, for example, comprise image data recorded by one or more imaging sensors, e.g. cameras, wherein the imaging sensors are in particular positioned at fixed points, e.g. along a production line. They can be used to train the AI model, to recognize defects, to monitor the production process and to improve the efficiency.

### Historical Data

The training image data can further comprise image data acquired in the past, e.g. from previous production cycles, including information about downtimes, defects and maintenance logs.

### Data From Sensors

The training image data can further comprise sensor data from further sensors that are described in more detail below.

According to one embodiment, the system further comprises at least one further sensor, wherein the AI model is further configured to output the output information additionally based on sensor data of the further sensor. For this purpose, the AI model was, for example, additionally trained with corresponding training sensor data. For example, a temperature sensor, pressure sensor, humidity sensor, speed sensor, acceleration sensor and/or vibration sensor can be used as a further sensor. Based on the sensor data, for example, the condition of the environment or the condition of objects, e.g. machines, within the environment can be determined. In a smart factory, for example, different types of sensors could be used to monitor the machines. The sensors can in this respect continuously acquire data, in particular in real time, and can send said data to a central database, for example. The sensor data are in particular converted into a form that can be processed by the AI model so that the AI model can thus be effectively trained.

According to one embodiment, the imaging sensor, the data processing unit and/or the further sensor is/are mounted on an autonomous vehicle. For example, the imaging sensor is mounted on an Automated Guided Vehicle (AGV) or an Autonomous Mobile Robot (AMR). For example, the autonomous vehicle can detect the environment by means of the imaging sensor and can continue to move within the environment. For example, the autonomous vehicle can be used in factories to perform a variety of tasks, such as the monitoring of stock levels or the recognition of obstacles. Different regions of the environment can be detected and/or monitored by means of the autonomous vehicle. The user interface can in particular be positioned at a different location than the imaging sensor or the autonomous vehicle. For example, from a fixed location at which the user interface is localized, the user of the system can, via a respective user query, obtain information about the remote region detected by the imaging sensor. It is generally also conceivable that the vehicle is a vehicle that can be controlled by the user, for example by remote control. In this case, the user himself can determine which region of the environment is detected by the imaging sensor.

According to one embodiment, the data processing unit comprises a programmable logic controller (PLC). Such PLCs are already used in many industrial platforms so that the implementation of the AI model on such a platform can take place easily without having to make cost-intensive hardware adaptations. In particular, no complex adaptations to the specific requirements and resources of the respective systems are necessary. The local application on the PLC furthermore offers considerable data protection advantages. Since the data processing can take place directly on the PLC, the personal data are not sent to external servers. This minimizes the risk of data leaks and facilitates compliance with data protection regulations.

According to one embodiment, the user interface comprises a display unit and is configured, as a result of a user query, to display sample image data and associated sample output information of the AI model on the display unit, wherein the AI model is optimized based on an evaluation of the sample output information by the user. For example, the user checks, based on the sample image data and the sample output information, whether the AI model answers an associated user query correctly or satisfactorily. The displayed sample image data in particular comprise image data that are stored in an internal, encrypted memory of the data processing unit, e.g. the PLC, for this purpose. For example, for a location-based query such as “Are pallets still present?”, a plurality of images are called up with a corresponding evaluation and the output of the AI model and/or the triggered response reaction is marked as “correct/incorrect” by the customer. The robustness of the output of the AI model can be further improved through active learning, for example, by suggesting relevant samples for the AI model in an automated manner.

According to one embodiment, the response action comprises at least one of the following actions: displaying the output information on the display unit of the user interface, storing the image data, the user query and/or the output information in a database, generating and transmitting a message to an external device, performing a safety action by means of a machine or outputting an acoustic and/or visual signal. Thus, via the response of the AI model displayed on the display unit, the user in particular receives a response in text form in natural language. Additionally or alternatively, the response can be output as an audio signal in spoken form. The outputs of the AI model can be stored in a database to analyze trends or to provide historical data for audits. The responses could further be transmitted to and integrated into existing systems in order, for example, to support processes such as inventory management or quality control. Furthermore, based on the output information of the AI model, notifications can be sent to smartphones, tablets or production dashboards if certain events, in particular predefined events, occur. For example, when a stock level is queried, a notification can be sent to a smartphone via which a responsible employee is informed if, for example, there is a shortage of goods in a warehouse. The response action can further comprise the automated creation and sending of corresponding notification emails. In principle, however, other actions can also be triggered, in particular in an automated manner, in response to the output information such as the starting of a maintenance process or the ordering of a cleaning. The response actions in particular comprise safety-directed actions, such as the stopping of devices in the environment, the outputting of an acoustic and/or visual warning signal and/or the outputting of safety messages to external devices.

According to one embodiment, the response action can be selected by the user via the user interface. For example, possible response actions, from which the user can select at least one that is then executed, are displayed to the user via the display unit of the user interface. In some cases, certain response actions can, for example, be in the primary interest of the user since they are, for example, relevant to safety, while other response actions may be irrelevant to the user, on the other hand. The system is thus flexible with regard to the respective present requirements and/or wishes of a user.

According to one embodiment, the image data and/or the training image data are encrypted and/or anonymized. In particular, the image data and/or training image data are stored in an internal memory of the PLC. The respective image data could, for example, be recorded and logged at a frequency of 1 Hz over a period of 48 hours. In particular, a strict anonymization is performed when acquiring and processing the image data and/or training image data to ensure that no information about natural persons is collected or stored. The acquired data will in particular be treated in accordance with the applicable data protection laws and regulations. The system can furthermore comprise a monitoring unit that performs, in particular in an automated manner, a continuous monitoring and checking of the outputs of the AI model for data protection violations and/or ethical guidelines. The above statements apply in the same way to the sensor data and/or the training sensor data.

According to one embodiment, the system is configured to process at least one of the following types of user queries: status queries, timeline queries, anomaly recognition queries, conditional queries or a combination thereof. The input user queries can therefore assume different forms and relate to different aspects of the region detected by the imaging sensor. The different types of user queries are, for example, characterized as follows:

### Status Queries

This type of query, for example, relates to the current status of the detected region. Examples of this are questions such as “Is there a person in the region?” or “How many pallets are still in room X?”.

### Timeline Queries

These queries, for example, relate to past events or status changes in the detected region. These include questions such as “Has event X occurred in the last 24 hours?” or “Has the number of pallets in room X changed in the last 2 hours?”.

### Anomaly Recognition Queries

Such queries, for example, relate to the identification of unusual events or deviations from expected patterns. For example, a user can ask “Has any unusual activity been detected in the last 12 hours?”.

### Conditional Queries

These queries are in particular used to perform or trigger certain actions or measures based on the acquired image data. For example, in addition to direct queries about the status of the detected region, a user can make a conditional query that contains a condition that must be satisfied so that a certain piece of information is provided and/or an action is triggered. The condition can refer to a single variable or a combination of a plurality of factors. Examples of this are “Send a warning to X when a movement is recognized” or “If there is an animal in the hall, check if you see an open door”.

According to one embodiment, the image data comprise sequences of images. In other words, the image data can be video image data. In such a case, the user can, for example, specify which features are to be viewed in the video. For this purpose, the user can, for example, select a region or an object within the captured image, wherein this information is made available to the AI model, in particular in a form that can be processed by the AI model. The advantage of this function is the ability to gain detailed insights into work sequences that would otherwise be difficult to measure. One use case would be questions such as “How long does it take to complete the work step?” or “How often is this tool used during a shift?”. A further example would be the monitoring of traffic flows in a logistics center. By analyzing videos, the speed of goods transports can be measured and optimal arrival times can be calculated. The advantage in particular lies in the precise data collection and the possibility of organizing traffic flows more efficiently.

According to one embodiment, the user interface is configured to receive user queries in the form of voice inputs. For example, the user interface for this purpose comprises a microphone via which the voice input of the user can be received and processed. Due to the possibility of the voice input, an even more intuitive and more user-friendly experience results for the user, whereby the use of time-consuming input devices, e.g. an input keyboard, can be reduced. For this purpose, the user interface can, for example, comprise a speech-to-text engine that converts the voice input into a text form that can then be processed by the AI model.

According to one embodiment, the data processing unit comprises a cloud on which the AI model is implemented, at least in part. The AI model can, for example, be executed within a cloud for efficiency reasons, wherein the data processing unit can furthermore comprise a physical processing unit that transmits the received image data and the user query data via a, preferably wireless, data connection to the cloud in which the AI model is executed. The output information of the AI model can then be transmitted via the data connection to the physical processing unit of the data processing unit. The execution of the AI model in a cloud offers a number of advantages:

Scalability: Cloud systems offer a high scalability since the complexity and/or the size of the AI model can be adapted in a simple manner to changing requirements. If, for example, the quantity of images to be processed increases, the cloud infrastructure can easily be scaled to cope with this additional load. In particular, existing AI models can be easily replaced by improved AI models. Since newer AI models are often more accurate and more efficient than older models, the performance of the image processing can be improved.

Swarm intelligence: By using the cloud, a form of swarm intelligence can be used to solve complex problems. For example, a plurality of image processing systems, i.e. AI models, can work together and share their results to provide even more accurate and robust evaluations. For example, a user query can be formulated on the basis of a temporally overlapping event chain: “If AGV 1 at location A sees that there is no more material available and AGV 2 also sees this at location B, arrange for AGV 3 to take a detour to pick up material and to transport it to locations A and B.”

Resource efficiency: Cloud systems can often be more resource-efficient than local systems, in particular when it comes to processing large volumes of data. Thus, additional expensive hardware can be dispensed with and the resources of the cloud can be accessed instead, in particular only when they are needed.

According to one embodiment, the data processing unit comprises an embedded device on which the AI model is implemented, at least in part. The embedded device can, for example, be a PLC of the system or safety system or of the industrial machine. The AI model implemented on the embedded device can, for example, comprise a small vision language model. Such small vision language models can require little computing power so that they can be runnable on the embedded device.

According to one embodiment, the AI model comprises a large language model (LLM), a large action model (LAM), an agentic system and/or a large vision model (LVM). The AI model in particular comprises a combination of the above models and can thus be a multimodal AI model that processes both text data and image data and can in particular execute or trigger actions. The AI model is therefore in particular a generative and/or predictive neural network. The neural network can in particular be a neural network based on transformer technology and/or an LSTM network, in particular an xLSTM network (extended LSTM). The LAM can be realized as a neurosymbolic AI model. By using a LAM, the user can not only ask questions about the content of the captured images, but can also specify specific scopes of action in their queries. For example, the system can process the following user query: “Ensure the most cost-efficient utilization of the AGV fleet, based on the material quantities in storage shelf A at location XYZ.”

The agentic system can comprise a plurality of agents, in particular autonomous agents, that cooperate with one another. These agents exchange information, coordinate their actions and dynamically adapt their strategies. The collaboration can be organized in a decentralized manner, with each agent making decisions locally, or it can be controlled centrally if a higher-level instance distributes the tasks.

As an example, the AI model can specifically comprise a combination of a vision transformer (ViT) and a large language model (LLM). For the visual processing of in particular the received image data, a so-called backbone can be used, which comprises the vision transformer (ViT) or a comparable model that extracts features from images. As the output of the backbone, the image representations can be forwarded as a token to the language model or LLM.

As a language model or LLM, the AI model can comprise a (powerful) pre-trained language model, e.g. LLaMA or GPT-like architectures. This model processes both the extracted visual features and the textual context.
The AI model can comprise a multimodal fusion in which the visual features are linked to the language model representation in a projection layer. The AI model can thereby use text information and image information at the same time.

The invention also relates to a method, in particular a safety method, preferably for controlling an industrial machine or an application in an industrial environment, for supporting a user in the evaluation of image data, said method comprising that: an environment is detected by at least one imaging sensor and associated image data are generated,
the image data are processed by at least one AI model with zero-shot capability, a user query is input in natural language via a user interface,
and, based on the image data and the user query, output information is output by the AI model, in particular in real time, in response to the user query, and
a response action is triggered based on the output information.

The statements regarding the system according to the invention apply accordingly to the method; this in particular applies with respect to advantages and embodiments.

It should be noted that any combination of the above embodiments is possible as long as this has not been explicitly excluded.

The invention will be presented purely by way of example with reference to the drawings in the following. There are shown:

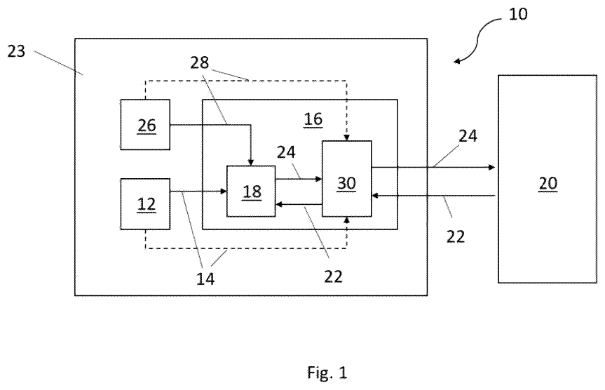

FIG. 1 a system for supporting a user in the evaluation of image data;

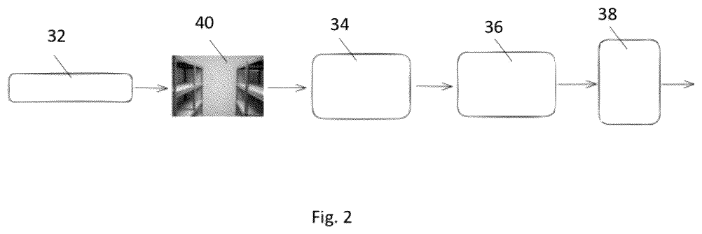

FIG. 2 a flowchart for illustrating a flow of information in the system;

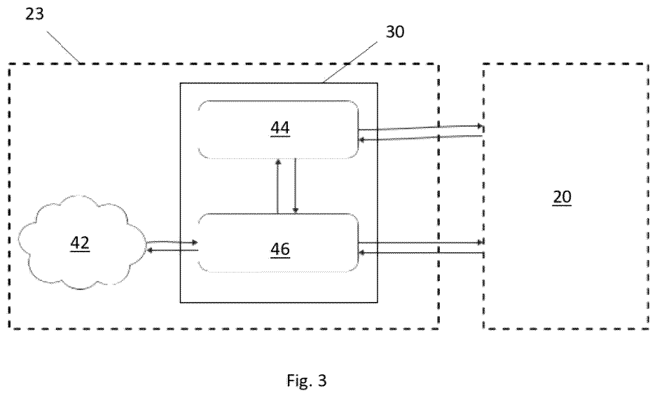

FIG. 3 an embodiment of the system in which an AI model is implemented on a cloud; and

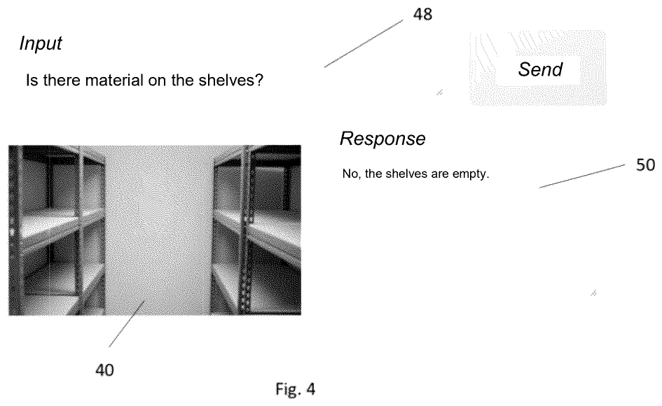

FIG. 4 respective inputs into a user interface of the system and associated outputs.

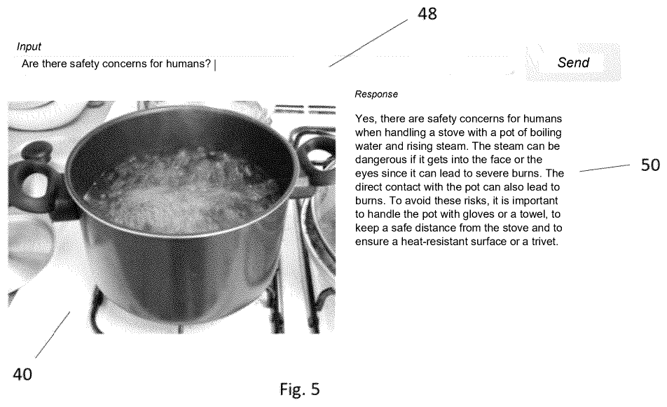

FIG. 5 respective inputs into a user interface of the system and associated outputs.

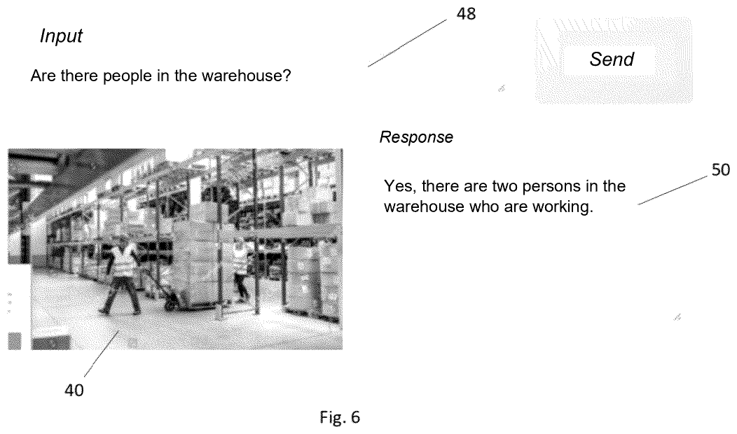

FIG. 6 respective inputs into a user interface of the system and associated outputs.

FIG. 1 shows a system 10 for supporting a user in the evaluation of image data. The system 10 comprises a camera 12 for detecting an environment and for generating associated image data 14, a data processing unit 16, such as a PLC, which comprises at least one AI model 18 with zero-shot capability for processing the image data 14, and a user interface 20 for inputting a user query 22 in natural language. The system further comprises a sensor 26, such as a speed sensor, that provides additional sensor data 28 with respect to the AGV 23 that can be processed by the AI model 18. The camera 12 and the data processing unit 16 are part of an AGV 23 that is located in a warehouse and that moves onward in an automated manner. Based on the image data 14 and the user query 22, the AI model 16 outputs output information 24 as a response to the user query 22, in particular in real time. Based on the output information 24, a response action is triggered by the data processing unit 16. The user interface 20 can in particular be designed as a text console without an image output function, as a website with a video stream function, text input function and text output function or as a GUI (graphical user interface) with a video stream function, text input function and text output function. The user interface is, for example, a graphical interface, a voice-based interface, a text-based interface and/or a gesture-based interface.

The data processing unit 16 further comprises an optional data connection interface 30 that provides an interface between the AI model 18 and the user interface 20. The data connection interface 30 can be realized via various forms of implementation. The data connection interface 30 is in particular designed as a translation interface in order to convert data of the user interface 20, the camera 12 and/or the sensor 26 into a form that can be processed by the AI model 18 and to convert data of the AI model 16 into a form that can be processed by the user interface 20. In this respect, the data connection interface 30 can have the following functions: video output, text output and text input.

FIG. 2 shows a flowchart for illustrating an information flow in the system 10. In a first step 32, an image 40 or the associated image data 14 is generated by the camera 12 of the system 10. The present image 40 is shown in FIG. 2 and shows two empty shelves. The user of the system 10 then, in a next step 34, inputs a user query 22 via the user interface 20 in natural language to determine, for example, whether material is present in the region captured by the camera 12, i.e., in the shelves shown. For this purpose, the user can, for example, formulate the following user query: “Is material still present?”. In a further step 36, the user query 22 is forwarded to the AI model 18 that generates corresponding output information 24 based on the image data 14 and the user query 22. The output information 24 is usually a text output in natural language. In a final step 38, a response action is triggered by the data processing unit 16 based on the output information 24. In other words, based on the text output of the AI model, an action such as the display of the output information via the user interface 20, the creation and sending of an e-mail to a responsible employee in which the current status of the shelves is pointed out, and the switching on of a signal light and the like is triggered.

FIG. 3 illustrates an embodiment of the system 10 in which the AI model 18 is implemented on a cloud 42. For the sake of simplicity, some components of the system 10, such as the camera 12, are not shown in FIG. 3.

In the present case, the data connection interface 30 is provided as a web server 44 with a REST API 46. By providing a web server 44 on the AGV 23, a platform-independent communication is possible so that external systems or user applications can interact with the system. To enable both a direct web interface and an automatic communication via API calls, the data connection interface 30 is configured as a combination of a web server 44 and a REST-API 46.

In addition, learning parameters of the AI model 18 can be managed via the data connection interface 30, in particular as part of an active learning process. These parameters can be adjusted or reported manually or automatically after the deployment. Furthermore, a synchronization of the learning parameters between a plurality of autonomous units, e.g. AGVs 23, can take place. A continuous optimization of the system on the basis of new data is thereby possible.

In the present embodiment, the AI model 18 is executed on a cloud 42, whereby an increased scalability, flexibility and an efficient use of resources are made possible. The data exchange between the REST-API 46 and the camera 12, not shown, and the cloud 42 in this respect takes place via a wireless data connection, in particular in real time.

FIGS. 4 to 6 illustrate respective inputs into a user interface 20 of the system 10 and the associated outputs. The user interface 20, for example, comprises a user interface in the form of a tablet on which the representation shown in FIGS. 4 to 6 is displayed. Via an input console 48, the user can in this respect submit any desired user query 22 that is then processed by the AI model 18 together with the image data 14 of the camera 12 in order to provide a response to the user query 22. The response is displayed in an output console 50. Additionally or alternatively, as shown in FIGS. 4 to 6, the image 40 currently captured by the camera 12 can be displayed to the user so that the user can validate the output of the AI model 18.

### REFERENCE NUMERAL LIST

10 system
12 camera
14 image data
16 data processing unit
18 AI model
20 user interface
22 user query
23 AGV
24 output information
26 sensor
28 sensor data
30 data connection interface
32-38 method steps
40 image
42 cloud
44 web server
46 REST API
48 input console
50 output console

1. A system for supporting a user in the evaluation of image data, said system comprising:
at least one imaging sensor for detecting an environment and for generating associated image data,
a data processing unit that comprises least one AI model with zero-shot capability for processing the image data,
and a user interface for inputting a user query in natural language,
wherein the AI model is configured to output, based on the image data and the user query, output information in response to the user query, and
wherein the data processing unit is configured to trigger a response action based on the output information.

2. The system according to claim 1,
wherein the AI model is trained based on training image data and associated training output information.

3. The system according to claim 1,
wherein the system further comprises at least one further sensor, wherein the AI model is further configured to output the output information additionally based on sensor data of the further sensor.

4. The system according to claim 3,
wherein the imaging sensor, the data processing unit and/or the further sensor is/are mounted on an autonomous vehicle.

5. The system according to claim 1,
wherein the data processing unit comprises a programmable logic controller.

6. The system according to claim 1,
wherein the user interface comprises a display unit and is configured, as a result of a user query, to display sample image data and associated sample output information of the AI model on the display unit, wherein the AI model is optimized based on an evaluation of the sample output information by the user.

7. The system according to claim 1,
wherein the response action comprises at least one of the following actions: displaying the output information on the display of the user interface, storing the image data, the user query and/or the output information in a database, generating and transmitting a message to an external device, performing a safety action by means of a machine or outputting an acoustic and/or visual signal.

8. The system according to claim 1,
wherein the response action can be selected by the user via the user interface.

9. The system according to claim 1,
wherein the image data and/or the training image data are encrypted and/or anonymized.

10. The system according to claim 1,
wherein the system is configured to process at least one of the following types of user queries: status queries, timeline queries, anomaly recognition queries, conditional queries or a combination thereof.

11. The system according to claim 1,
wherein the image data comprise sequences of images.

12. The system according to claim 1,
wherein the user interface is configured to receive user queries in the form of voice inputs.

13. The system according to claim 1,
wherein the data processing unit comprises a cloud on which the AI model is implemented.

14. The system according to claim 1,
wherein the AI model comprises a large language model, a large action model, an agentic system and/or a large vision model.

15. A method for supporting a user in the evaluation of image data, said method comprising that:
an environment is detected by at least one imaging sensor and associated image data are generated,
the image data are processed by at least one AI model with zero-shot capability,
a user query is input in natural language via a user interface,
and, based on the image data and the user query, output information is output by the AI model in response to the user query, and
a response action is triggered based on the output information.

16. The system according to claim 1, wherein the system is a safety system.

17. The system according to claim 1, wherein the AI model is configured to output the output information in response to the user query in real time.

18. The system according to claim 2,
wherein the training image data are based on the detected environment.

19. The method according to claim 15, wherein the method is a safety method.

20. The method according to claim 15, wherein the output information is output by the AI model in real time.
